(19) United States
(12) Patent Application Publication
(10) Pub. No.: US 2016/0092131 A1
(43) Pub. Date: Mar. 31, 2016

(54) STORAGE SYSTEM, STORAGE SYSTEM CONTROL METHOD, AND RECORDING MEDIUM STORING VIRTUAL TAPE DEVICE CONTROL PROGRAM

(71) Applicant: NEC Corporation, Tokyo (JP)

(72) Inventors: Makoto NAKAJIMA, Tokyo (JP); Hajime NONAKA, Tokyo (JP); Muneyuki YOSHIKAWA, Tokyo (JP); Yuuki HAYAKAWA, Tokyo (JP)

(73) Assignee: NEC Corporation, Tokyo (JP)

(21) Appl. No.: 14/862,461

(22) Filed: Sep. 23, 2015

(30) Foreign Application Priority Data
Sep. 25, 2014 (JP) 2014-195310

(51) Int. Cl. G06F 3/06

(52) U.S. Cl. CPC G06F 3/0619; G06F 3/0643; G06F 3/0661; G06F 3/0665; G06F 3/0686

(57) ABSTRACT

A storage system according to an aspect of the present invention includes: a virtual tape device that includes circuitry configured to operate as a management unit that reads a data set from a virtual tape storage unit that stores the data set, the data set including, in an associated manner, a piece of virtual tape data including a piece of user data stored in a virtual tape and management data including a piece of location data indicating a storage location at which the piece of virtual tape data is stored, a conversion unit that generates a virtual tape file including the data set, and a transfer unit that transmits the virtual tape file as transfer data to an external storage device; and the external storage device that stores the transfer data upon receipt of the transfer data.

This application is based upon and claims the benefit of priority from Japanese Patent Application No. 2014-195310, filed on Sep. 25, 2014, the disclosure of which is incorporated herein in its entirety by reference.

### TECHNICAL FIELD

The present invention relates to a technology of controlling a virtual tape.

### BACKGROUND ART

As a method for maintaining data integrity in anticipation of disaster, there are methods of saving data at a different location such as a backup center set up at a remote site. As storage device for saving data, a magnetic tape device is often used. In such a case, in order to save data at a remote site, a magnetic tape medium on which the data is recorded using a magnetic tape device is physically transported to the remote site by a truck, for example.

In recent years, a virtual tape device, which virtually emulates a magnetic tape device and a magnetic tape medium in a magnetic disk device, is used instead of a magnetic tape device in many cases.

As an integrity method for saving data recorded using a virtual tape device, at a remote site, there is, for example, a method of creating a copy of a virtual tape on a medium such as a magnetic tape and transporting the medium, such as a magnetic tape, which includes the copy, is physically transported to a remote site. As an integrity method for saving data recorded using a virtual tape device, at a remote site without requiring any physical transportation, there is a method of preparing the same virtual tape device at a remote site and creating a copy of a virtual tape in the virtual tape device set up in the remote site by use of a replication function.

Japanese Unexamined Patent Application Publication No. 2009-129022 (PTL 1) discloses a tape management system that allows multiple programs to use a file recorded on a virtual tape. When a request for permission to use a virtual tape volume that is being used by a program is issued by a different program, the tape management system described in PTL 1 creates a temporary virtual tape volume on a magnetic disk. The tape management system described in PTL 1 sets the virtual tape volume that is temporarily created, as the access destination of the program that has issued the request for permission to use the currently used virtual tape volume.

Japanese Unexamined Patent Application Publication No. 2009-043162 (PTL 2) discloses a virtual library device that emulates medium export of a virtual tape volume. The virtual library device of PTL 2 creates copies of logical volumes stored in a storage medium of the virtual library device (i.e., virtual tape volumes) together in an external mass storage medium. The external storage medium is stored in a site such as a storehouse.

Japanese Unexamined Patent Application Publication No. 2007-293778 (PTL 3) also discloses a virtual library device that emulates export and the like of a virtual tape from the virtual library device. The library device of PTL 3 emulates export of a virtual tape represented by virtual tape management information by moving the virtual tape management information, for example, to a storage area designated as export destination. The virtual library device writes the data in the exported virtual tape, to a magnetic tape. The virtual library device then deletes the data of the virtual tape written in the magnetic tape.

Japanese Unexamined Patent Application Publication No. 2004-227448 (PTL 4) discloses a tape management system that transfers a virtual tape recorded in a virtual tape device to a remote system and allows the remote system to use the virtual tape. The tape management system described in PTL 4 creates separate files for a data section and a management information section (name of the virtual tape, control information, and recorded location information on the data division file) of a dataset of a virtual tape stored in the virtual tape device. The tape management system creates a copy of the data section in a remote magnetic disk device by use of the function of making a copy between magnetic disk devices, without using any file system. The tape management system updates the management information section with the storage location at the copy destination. The tape management system transmits the management information section to a device using the magnetic disk through a different route, so that the device can interpret the data in the magnetic disk as a virtual tape.

### SUMMARY

The present invention has an object to provide a virtual tape device capable of reducing the cost of backing up a virtual tape without increasing the load on a host device.

A storage system according to an aspect of the present invention includes: a virtual tape device that includes circuitry configured to operate as a management unit that reads a data set from a virtual tape storage unit that stores the data set, the data set including, in an associated manner, a piece of virtual tape data including a piece of user data stored in a virtual tape and management data including a piece of location data indicating a storage location at which the piece of virtual tape data is stored, a conversion unit that generates a virtual tape file including the data set, and a transfer unit that transmits the virtual tape file as transfer data to an external storage device; and the external storage device that stores the transfer data upon receipt of the transfer data.

A storage system control method according to an aspect of the present invention includes: reading, by a virtual tape device, a data set from a virtual tape storage unit that stores the data set, the data set including, in an associated manner, a piece of virtual tape data including a piece of user data stored in a virtual tape and management data including a piece of location data indicating a storage location at which the piece of virtual tape data is stored, generating a virtual tape file including the data set, and transmitting the virtual tape file as transfer data to an external storage device; and storing, by the external storage device, the transfer data upon receipt of the transfer data.

A non-transitory computer-readable recording medium according to an aspect of the present invention stores a virtual tape device control program causing a computer to operate as: a management unit that reads a data set from a virtual tape storage unit that stores the data set, the data set including, in an associated manner, a piece of virtual tape data including a piece of user data stored in a virtual tape and management data including a piece of location data indicating a storage location at which the piece of virtual tape data is stored; a conversion unit that generates a virtual tape file including the data set; and a transfer unit that transmits, upon receipt of the transfer data, the virtual tape file as transfer data to an external storage device that is to store the transfer data.

### BRIEF DESCRIPTION OF THE DRAWINGS

Exemplary features and advantages of the present invention will become apparent from the following detailed description when taken with the accompanying drawings in which:

FIG. 1 is a block diagram illustrating an example of a configuration of an information processing system 100 of a first exemplary embodiment of the present invention;

FIG. 2 is a diagram schematically illustrating relationship between a virtual tape image and a virtual tape file;

FIG. 3 is a diagram schematically illustrating an example of a data structure of a virtual tape volume of the first exemplary embodiment of the present invention;

FIG. 4 is a diagram schematically illustrating relationship between pieces of user data stored in the virtual tape volume and pieces of user data included in a virtual tape file in the first exemplary embodiment of the present invention;

FIG. 5 is a flowchart illustrating an example of operation of a virtual tape device 1 of the first exemplary embodiment of the present invention at the time of transmitting a virtual tape file;

FIG. 6 is a flowchart illustrating an example of operation of the virtual tape device 1 of the first exemplary embodiment of the present invention at the time of receiving a virtual tape file;

FIG. 7 is a block diagram illustrating an example of a configuration of an information processing system 100A of second and third exemplary embodiments of the present invention;

FIG. 8 is a diagram schematically illustrating relationship between pieces of data stored in a virtual tape volume and pieces of data stored in a virtual tape file in the second exemplary embodiment of the present invention;

FIG. 9 is a flowchart illustrating an example of operation of a virtual tape device 1A of the second exemplary embodiment of the present invention at the time of transmitting a virtual tape file;

FIG. 10 is a flowchart illustrating an example of operation of the virtual tape device 1A of the second and third exemplary embodiments of the present invention at the time of receiving a virtual tape file;

FIG. 11 is a diagram schematically illustrating relationship between pieces of data stored in a virtual tape file transmitted from an external storage 4 and pieces of data stored in a virtual tape volume in the second exemplary embodiment;

FIG. 12 is a flowchart illustrating an example of operation of the virtual tape device 1A of the third exemplary embodiment of the present invention at the time of transmitting a virtual tape file;

FIG. 13 is a diagram schematically illustrating relationship between pieces of data stored in a virtual tape volume and pieces of data stored in a virtual tape file in the third exemplary embodiment;

FIG. 14 is a diagram schematically illustrating an example of a virtual tape before and after conversion in which a conversion unit 14 sets a disk location at a value;

FIG. 15 is a diagram schematically illustrating an example of a virtual tape before and after conversion in which the conversion unit 14 sets a disk location at a value;

FIG. 16 is a block diagram illustrating an example of a configuration of a storage system 110B of a fourth exemplary embodiment of the present invention; and

FIG. 17 is a diagram illustrating an example of a hardware configuration of a computer 1000 capable of implementing a virtual tape device according to each of the exemplary embodiments of the present invention; and

FIG. 18 is a block diagram illustrating an example of a structure of a virtual tape device according to exemplary embodiments of the present invention.

### EXEMPLARY EMBODIMENT

### First Exemplary Embodiment

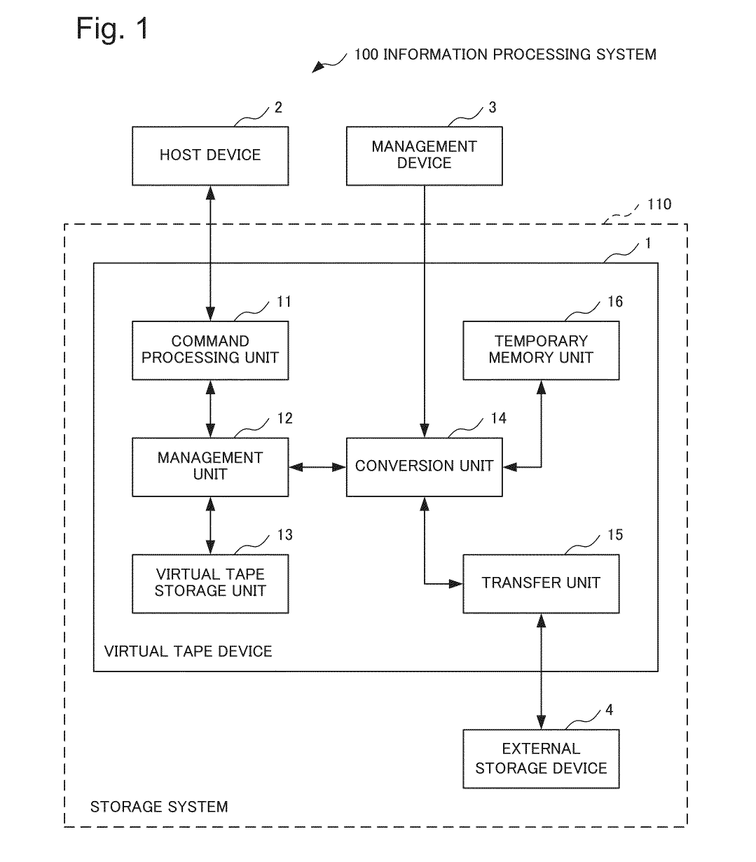

Next, a first exemplary embodiment of the present invention is described in detail with reference to FIGS. 1 to 6.

FIG. 1 is a block diagram illustrating an example of a configuration of an information processing system 100 of the present exemplary embodiment. With reference to FIG. 1, the information processing system 100 includes a storage system 110, a host device 2, and a management device 3. The storage system 110 includes a virtual tape device 1 and an external storage device 4. The virtual tape device 1 is communicably connected to the host device 2, the management device 3, and the external storage device 4 via a communication network, for example.

The virtual tape device 1 includes a command processing unit 11, a management unit 12, a virtual tape storage unit 13, a conversion unit 14, a transfer unit 15, and a temporary memory unit 16.

A virtual tape volume is generated and stored in the virtual tape storage unit 13. A plurality of virtual tape volumes may be generated and stored in the virtual tape storage unit 13. The virtual tape volume stores virtual tape data emulating a magnetic tape. In addition, the virtual tape volume stores virtual volume information including a label of the virtual tape volume and data indicating the capacity of the virtual tape volume. The virtual tape volume also stores management data including location data indicating a location at which the virtual tape data is stored. The virtual tape volume is described later in detail.

The host device 2 transmits a data write command and a data read command to the virtual tape device 1. In the following description, data that the host device 2 writes to the virtual tape device 1 is referred to as “user data”. The host device 2 transmits user data to write, in addition to a data write command, to the virtual tape device 1. In response to the data read command which the host device 2 transmits, the host device 2 receives the user data transmitted from the virtual tape device 1 to the host device 2.

The command processing unit 11 receives a write command and data to be written, from the host device 2. The command processing unit 11 transmits the data to be written, which is received from the host device 2, and an instruction to write the data to the virtual tape volume, to the management unit 12. The command processing unit 11 receives, from the host device 2, a read command to read data (hereinafter, referred to as target data). The command processing unit 11 transmits, to the management unit 12, an instruction to read the target data from the virtual tape volume. The target data is data which the host device 2 instructs, using the read command received by the command processing unit 11, the virtual tape device 1 to read. The management unit 12 reads the target data form the virtual tape volume in the virtual tape storage unit 13, and transmit the read target data to the command processing unit 11. The command processing unit 11 transmits, to the host device 2, the data (i.e. the target data) read from the virtual tape volume by the management unit 12.

According to an instruction from the command processing unit 11, the management unit 12 writes data to the virtual tape volume, updates the management data in the virtual tape volume, or reads data from the virtual tape volume and returns the read data. The management data in the virtual tape volume includes a location at which the virtual tape data is stored in the virtual tape volume, a size of the virtual tape data, and the like. The virtual tape volume may include pieces of the virtual tape data. In this case, the management data includes locations at which the pieces of the virtual tape data stored in the virtual tape volume, sizes of the pieces of the virtual tape data, and the like. Though only a piece of the user data may be included in the virtual tape file and in the virtual tape volume, the virtual tape file and the virtual tape volume each including pieces of user data are described in the description of the exemplary embodiments of the present invention. In the following description, management data is also referred to as “data location information list”.

In addition to the above, according to an instruction from the conversion unit 14, the management unit 12 reads virtual volume information corresponding to data on the virtual volume, the management data, and pieces of the virtual tape data, from the virtual tape volume. Moreover, according an instruction from the conversion unit 14, the management unit 12 writes the virtual volume information corresponding to data on the virtual volume, the management data, and pieces of the virtual tape data to the virtual tape volume. Further, according an instruction from the conversion unit 14, the management unit 12 generates a virtual tape volume in the virtual tape storage unit 13.

According to an instruction from the management device 3, the conversion unit 14 obtains the pieces of user data stored in a specified virtual tape volume, from the management unit 12. The conversion unit 14 converts the obtained pieces of user data into a virtual tape file. The virtual tape file includes the pieces of user data recorded in the order of being stored in the virtual tape volume. The conversion unit 14 stores the virtual tape file obtained by converting the pieces of user data in the temporary memory unit 16.

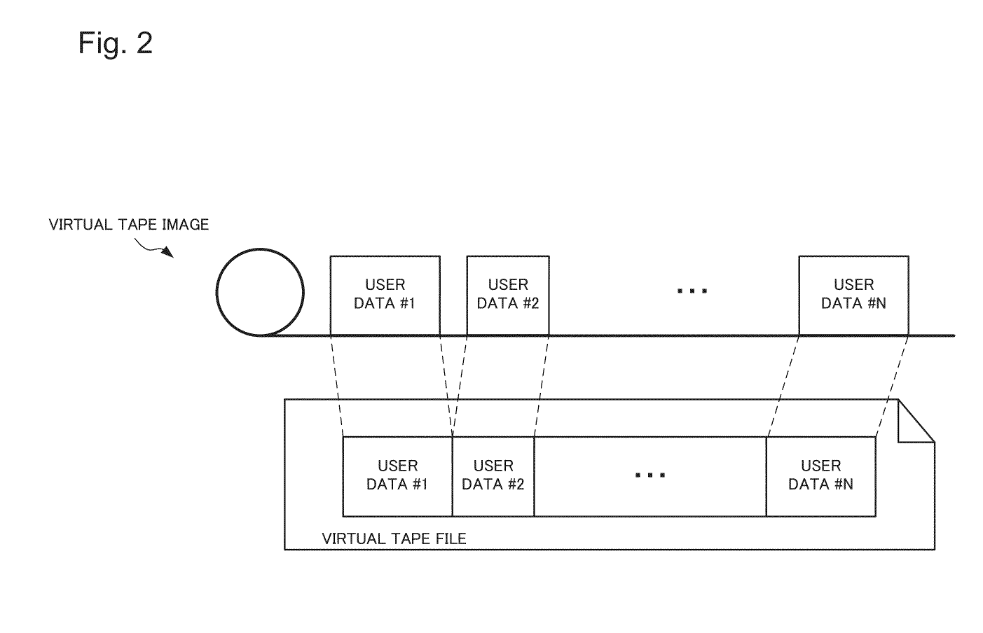

FIG. 2 is a diagram schematically illustrating relationship between a virtual tape image and a virtual tape file. When pieces of user data is stored in the virtual tape image as shown in FIG. 2, the pieces of the user data are stored with a prefixed gap between each two adjacent pieces of the user data. In the virtual tape file, the pieces of the user data are stored without any gap therebetween.

In addition to the above, according to an instruction from the management device 3, the conversion unit 14 receives a virtual tape file specified by the management device 3 from the external storage device 4 via the transfer unit 15. Specifically, the conversion unit 14 may transmit an instruction to receive the specified virtual tape file to the transfer unit 15. When receiving the instruction to receive the specified virtual tape file, the transfer unit 15 may transmit, to the external storage device 4, an instruction to transmit the specified virtual tape file. The transfer unit 15 may receive the specified virtual tape file from the external storage device 4 and transmit the received virtual tape file to the conversion unit 14. The conversion unit 14 converts the received virtual tape file into a virtual tape volume created in the virtual tape storage unit 13. The virtual tape file may be stored in the temporary memory unit 16. The conversion unit 14 may transmit, to the management unit 12, an instruction to generate a virtual tape volume having a label specified by the management device 3. The conversion unit 14 converts the pieces of user data included in the virtual tape file into respective pieces of virtual tape data. The conversion unit 14 then transmits, to the management unit 12, the pieces of virtual tape data obtained by the conversion and an instruction to store the virtual tape data in the virtual tape volume.

The transfer unit 15 receives a virtual tape file from the conversion unit 14. According to an instruction from the conversion unit 14, the transfer unit 15 transmits the virtual tape file received from the conversion unit 14, to the external storage device 4. In addition, the transfer unit 15 receives, from the external storage device 4, a virtual tape file transmitted by the external storage device 4. The transfer unit 15 transmits the virtual tape file received from the external storage device 4, to the conversion unit 14. Any of various known communication protocols is applicable to a protocol for communications between the transfer unit 15 and the external storage device 4. Examples of such protocols are a file transfer protocol (FTP) and a common Internet file protocol (CIFS).

The external storage device 4 includes a communication function and is communicably connected with the virtual tape device 1 via the above-mentioned communication network. The external storage device 4 stores files received from the virtual tape device 1. According to a file transmission request from the virtual tape device 1, the external storage device 4 transmits, from among the stored files, the file transmission of which is requested by the transmission request, to the virtual tape device 1. The external storage device 4 is able to be implemented by, for example, a computer including a communication function and a storage area.

The management device 3 is a terminal that is communicably connected to the virtual tape device 1 and is capable of receiving operation by the user using the management device 3. The management device 3 transmits, to the conversion unit 14, a label indicating the virtual tape volume that is specified by the user to be transmitted to the external storage device 4 as a virtual tape file. The management device 3 also transmits, to the conversion unit 14, a file identifier identifying the file that the virtual tape device 1 is to receive from the external storage device 4.

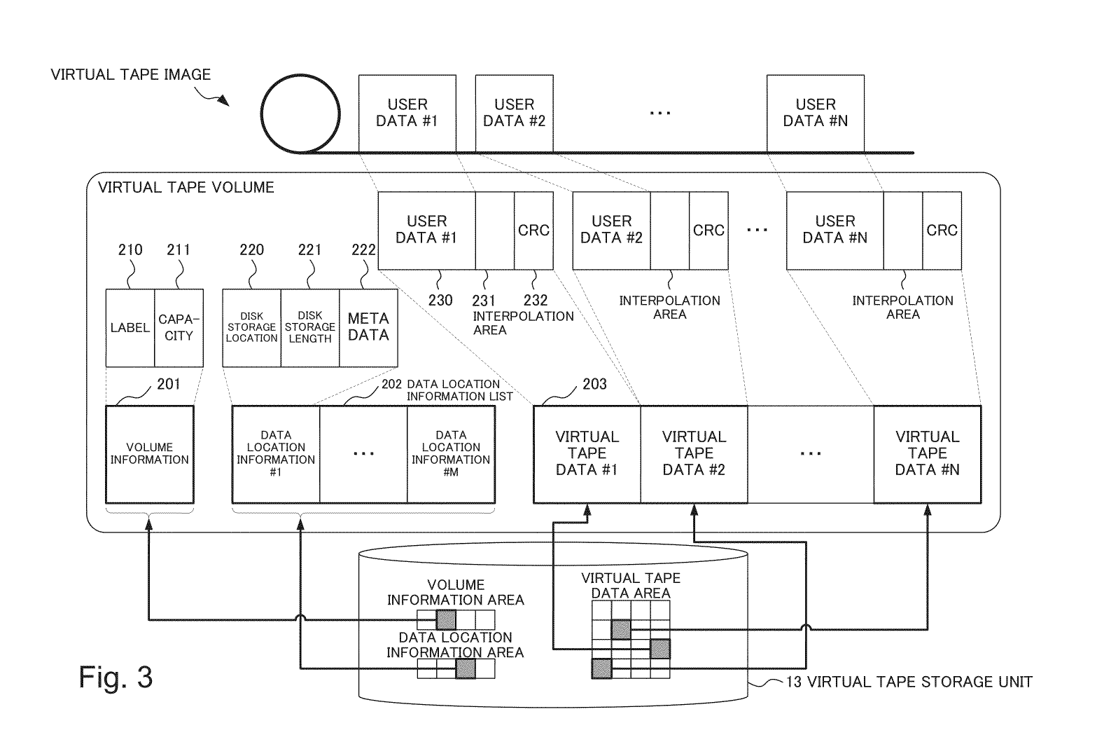

Next, a data structure of a virtual tape volume created in the virtual tape storage unit 13 is described by use of FIG. 3. FIG. 3 is a diagram schematically illustrating an example of the data structure of a virtual tape volume of the present exemplary embodiment.

As illustrated in FIG. 3, a virtual tape volume is implemented by using volume information 201, a data location information list 202, and a plurality of pieces of virtual tape data 203. The volume information 201, the data location information list 202, and the plurality of pieces of virtual tape data 203 are recorded in a volume information area, a data location information area, and a virtual tape data area, respectively, which are arranged in a storage area of the virtual tape storage unit 13.

The volume information 201 includes, for example, a label 210 and a capacity 211. The label 210 is a virtual tape identifier being able to identify a virtual tape stored in the virtual tape volume. The label 210 may be any data value as long as being uniquely set for the virtual tape in the virtual tape device 1. The label 210 may be represented by a character string. The capacity 211 corresponds to the total size of the pieces of user data included in the virtual tape volume. The data location information list 202 includes pieces of data location information on the respective pieces of the virtual tape data included in the virtual tape volume. The each of the pieces of the data location information on the virtual tape data includes a disk storage location 220, a disk storage length 221, and a piece of metadata 222 of the related piece of the virtual tape data. The disk storage location 220 indicates the location (i.e., address), in the virtual tape storage unit 13, of the beginning of the storage area in which the related piece of the virtual tape data is stored. The disk storage length 221 indicates the size of the piece of virtual tape data stored in the virtual tape storage unit 13. The metadata 222 includes attributes such as the length, the block type, and the sequential number of the block of the user data.

The virtual tape data 203 includes a piece of user data 230, an interpolation area 231, and a cyclic redundancy check (CRC) 232. The piece of user data 230 is data transmitted by the host device 2 and for which a write instruction is issued by the host device 2. The interpolation area 231 is data additionally included in the piece of virtual tape data 203 for the purpose of adjusting the size of the virtual tape data 203 to have a length (e.g., a certain size) suitable for a process by the virtual tape device 1. The interpolation area 231 is always cleared to zero, for example. The CRC 232 is data that is able to be used for error detection for ensuring the integrity of the piece of user data 230.

The virtual tape volume is implemented by using the above-described management information. At the same time, in response to receipt of a write command or read command for a magnetic tape, the virtual tape device 1 operates in accordance with the received command. For this reason, the virtual tape device 1 appears, when seen from the host device 2, to be a magnetic tape medium in which pieces of data are sequentially arranged as one illustrated as a virtual tape image in FIG. 2.

The virtual tape file of the present exemplary embodiment is a file including a collection of pieces of user data. Any of various known formats is applicable to the virtual tape file. An example of the format usable for the virtual tape file is a recording format for data exchange defined by JEITA IT-1003, which is a standard by Japan Electronics and Information Technology Industries Association (JEITA).

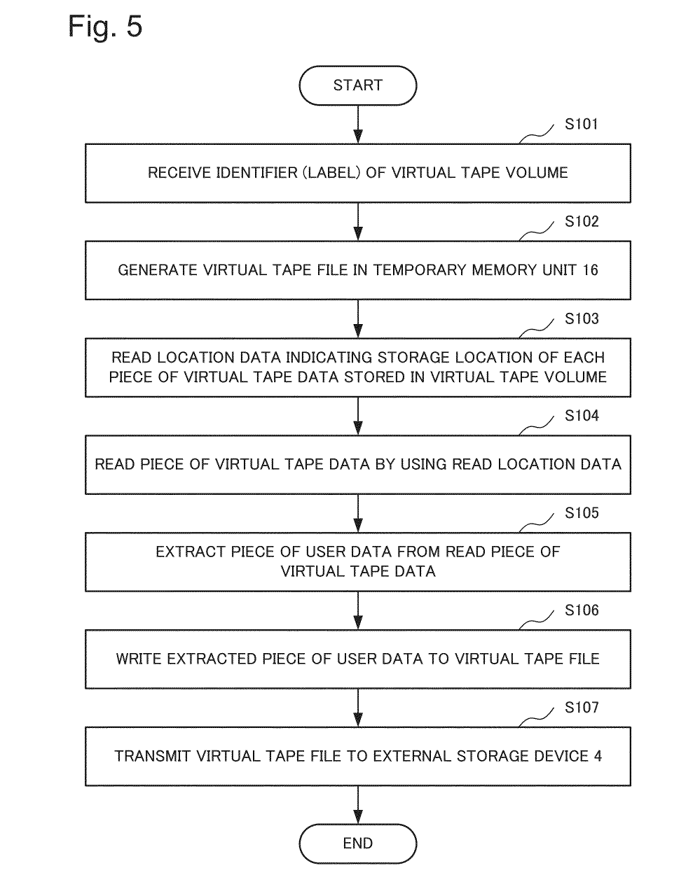

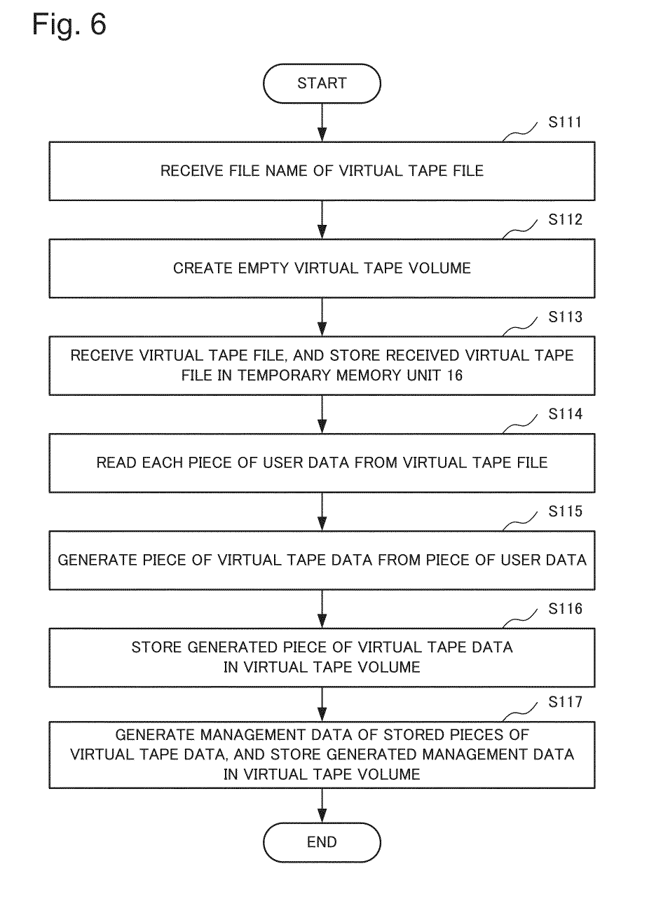

Next, operation of the first exemplary embodiment of the present invention is described with reference to FIGS. 5 and 6.

FIG. 5 is a flowchart illustrating an example of operation of the virtual tape device 1 of the present exemplary embodiment at the time of transmitting a virtual tape file. FIG. 5 presents an operation of outputting, as a file, a virtual tape volume specified by the management device 3. The management device 3 transmits the label of a virtual tape volume to the virtual tape device 1, and provides the virtual tape device 1 with an instruction to output, as a file, the virtual tape volume indicated by the label, thereby starting the operation illustrated in FIG. 5.

First, the conversion unit 14 receives the identifier (i.e., label) of the virtual tape volume from the management device 3 (Step S101). Then, the conversion unit 14 creates an empty virtual tape file in the temporary memory unit 16 (Step S102). According to an instruction from the conversion unit 14, the management unit 12 reads the data location information list from the virtual tape volume (Step S103). The management unit 12 reads the pieces of the user data from the starting of the virtual tape, which is represented by the virtual tape volume, in the virtual tape image. The management unit 12 sequentially reads the pieces of the data location information included in the data location information list from the first piece of the data location information. Then, the management unit 12 reads the piece of the virtual tape data from the virtual tape data area indicated by each of the read pieces of the data location information (Step S104). Then, the management unit 12 extracts a piece of the user data from the read piece of the virtual tape data (Step S105). The management unit 12 transmits the extracted piece of the user data to the conversion unit 14. The conversion unit 14 writes the received piece of the user data to the virtual tape file (Step S106). The management unit 12 reads the pieces of the user data to the end of the virtual tape volume (i.e., all pieces of user data), and when the conversion of the pieces of the user data to the virtual tape file is completed, the transfer unit 15 transmits the virtual tape file stored in the temporary memory unit 16, to the external storage device 4 (Step S107).

Next, description is given of operation of the virtual tape device 1 of the present exemplary embodiment at the time of receiving a virtual tape file, with reference to FIG. 6.

FIG. 6 is a flowchart illustrating an example of operation of the virtual tape device 1 of the present exemplary embodiment at the time of receiving a virtual tape file. When the management device 3 instructs the virtual tape device 1 to input a virtual tape file, the virtual tape device 1 starts the operation illustrated in FIG. 6. The management device 3 may instruct the virtual tape device 1 to input a virtual tape file by transmitting, for example, a corresponding tape file name to the conversion unit 14.

First, the conversion unit 14 receives the file name of the virtual tape file from the management device 3 (Step S111). The conversion unit 14 instructs the management unit 12 to create an empty virtual tape volume. The management unit 12 creates an empty virtual tape volume in the virtual tape storage unit 13 (Step S112). The label included in the volume information in the virtual tape volume created in Step S112 may be, for example, the file name received in Step S111. The capacity included in the volume information may be, for example, zero. The conversion unit 14 transmits the received file name of the virtual tape file to the external storage device 4 via the transfer unit 15 and thereby instructs the external storage device 4 to transmit the virtual tape file indicated by the transmitted file name. The transfer unit 15 receives the virtual tape file from the external storage device 4. The transfer unit 15 stores the received virtual tape file in the temporary memory unit 16 via the conversion unit 14 (Step S113).

The conversion unit 14 sequentially selects the pieces of the user data stored in the virtual tape file from the first piece and reads each selected piece of the user data (Step S114). The conversion unit 14 transmits the read piece of the data to the management unit 12. The management unit 12 generates a piece of virtual tape data on the basis of the received piece of user data (Step S115). Specifically, the management unit 12 generates a piece of virtual tape data by adding an interpolation area and a CRC calculated using the piece of user data, to the piece of the user data.

In addition to the above, the management unit 12 reserves an area in which the piece of virtual tape data is able to be stored, in the virtual tape volume created in the virtual tape storage unit 13. The management unit 12 stores the piece of the virtual tape data in the reserved area in the virtual tape volume (Step S116). The management unit 12 also generates a piece of the management data (i.e., data location information described above) on the stored piece of virtual tape data. Then, the management unit 12 stores the generated piece of the management data in the virtual tape volume (Step S117). Upon completion of reading the pieces of the user data to the end of the virtual tape file, the management unit 12 updates the capacity in the volume information in the virtual tape volume. Thereafter, the virtual tape device 1 terminates the operation illustrated in FIG. 6.

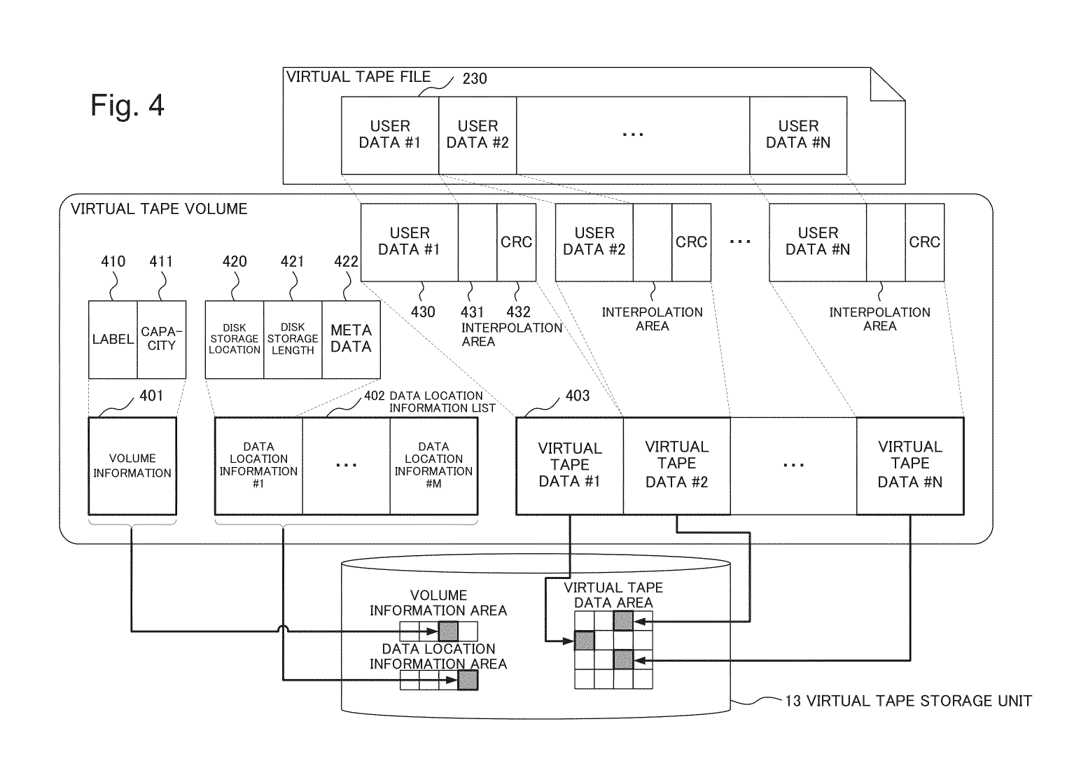

FIG. 4 is a diagram schematically illustrating relationship between the pieces of user data stored in a virtual tape volume and the pieces of user data included in a virtual tape file received from the external storage device 4 in the present exemplary embodiment. The virtual tape file received from the external storage device 4 includes the pieces of user data 230. The virtual tape file received from the external storage device 4 does not include any of volume information, a data location information list, interpolation areas, or CRCs. The management unit 12 creates a CRC 432 by using each of the pieces of the user data 230. Then, the management unit 12 creates a piece of the virtual tape data 403 by adding an interpolation area 431 and the CRC 432 to each piece of the user data 430, which is the same as the corresponding piece of the user data 230. Then, the management unit 12 stores the pieces of the virtual tape data 403 in the virtual tape volume. In other words, the management unit 12 stores, in the virtual tape volume, the pieces of the user data 230 as the pieces of the user data 430 included in the respective pieces of the virtual tape data 403. The management unit 12 sets a disk storage location 420 and a disk storage length 421 according to the user data 430 and the location at which the user data 430 is stored. Then, the management unit 12 appropriately generates a piece of metadata 422 relating to the user data 430. The piece of metadata 422 the may be the same as the piece of metadata 222. The management unit 12 writes, to the virtual tape volume, a data location information list 402, which includes pieces of the data location information each including the disk storage location 420, the disk storage length 421, and the piece of the metadata 422. The management unit 12 also writes volume information 401 including a label 410 and a capacity 411, which are set appropriately, to the virtual tape volume.

The present exemplary embodiment described above has the effect of reducing the cost of backing up a virtual tape without increasing the load of the host device 2.

The reason is because the conversion unit 14 creates a virtual tape file including the pieces of the user data stored in a virtual tape volume and the transfer unit 15 transmits the created virtual tape file to the external storage device 4, which stores received data. Because of this operation, the host device 2 does not carry out the process of storing, in the external storage device 4, the data stored in the virtual tape volume as a virtual tape. Hence, the load of the host device 2 is reduced. Moreover, the external storage device 4 is able to be implemented by a general network-attached storage (NAS) or cloud storage. Hence, the cost of the external storage device 4 is able to be reduced compared with a case of using, as the external storage device 4, a virtual tape device equivalent to the virtual tape device 1.

### Second Exemplary Embodiment

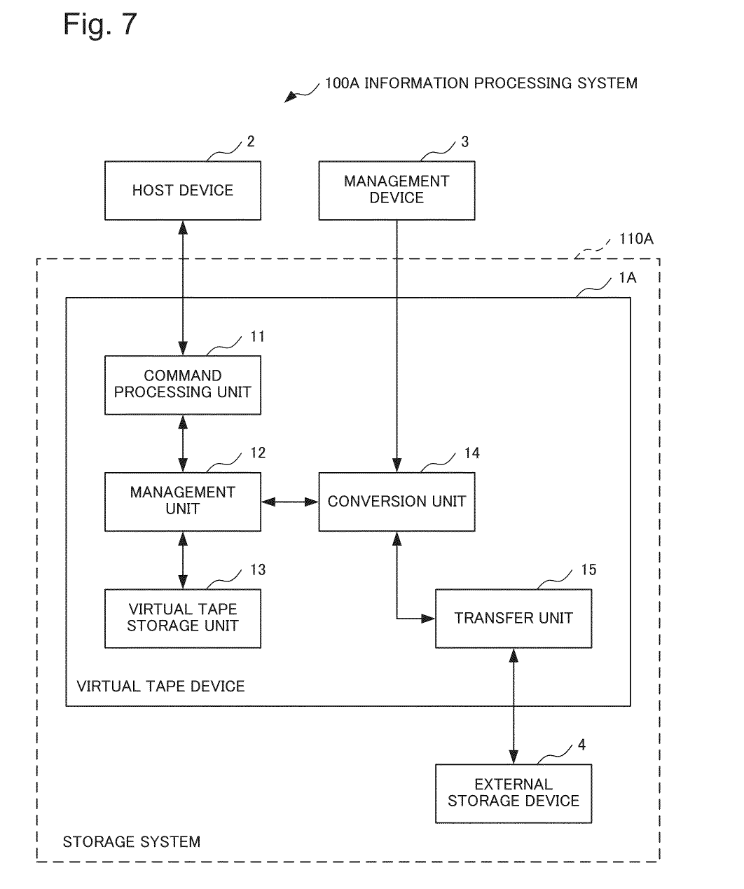

Next, a second exemplary embodiment of the present invention is described in detail with reference to FIGS. 7 to 11.

The virtual tape device 1 of the first exemplary embodiment transfers, to the external storage device 4, the pieces of the user data stored in the virtual tape volume without increasing the load on the host device 2. However, the virtual tape device 1 of the first exemplary embodiment carries out the process of extracting the pieces of the user data by interpreting one by one the pieces of the user data in the entire virtual tape volume. For this reason, load on the management unit 12 and the conversion unit 14, which carry out the process, increases. This may affect the process carried out by the host device 2 for a different virtual volume created in the virtual tape storage unit 13. The present exemplary embodiment described below inputs and outputs a virtual tape file without increasing the load on the management unit 12 and the conversion unit 14 to a large extent.

FIG. 7 is a block diagram illustrating an example of a configuration of an information processing system 100A of the present exemplary embodiment. In comparison with the information processing system 100 of the first exemplary embodiment, the information processing system 100A of the present exemplary embodiment includes a storage system 110A instead of the storage system 110. In comparison with the storage system 110, the storage system 110A includes a virtual tape device 1A instead of the virtual tape device 1. In comparison with the virtual tape device 1, the virtual tape device 1A does not include the temporary memory unit 16. The constituent elements of the virtual tape device 1A are the same as the constituent elements to which the same numerals are assigned in the virtual tape device 1 of the first exemplary embodiment, except for the differences described below.

The management unit 12 of the present exemplary embodiment reads pieces of data in the virtual tape volume specified by the management device 3 by way of transmitting, for example, a label, in the virtual tape volumes created in the virtual tape storage unit 13, without changing the data structure. The conversion unit 14 transmits, as a virtual tape file, the pieces of the data read by the management unit 12 to the external storage device 4 via the transfer unit 15 without changing the data structure.

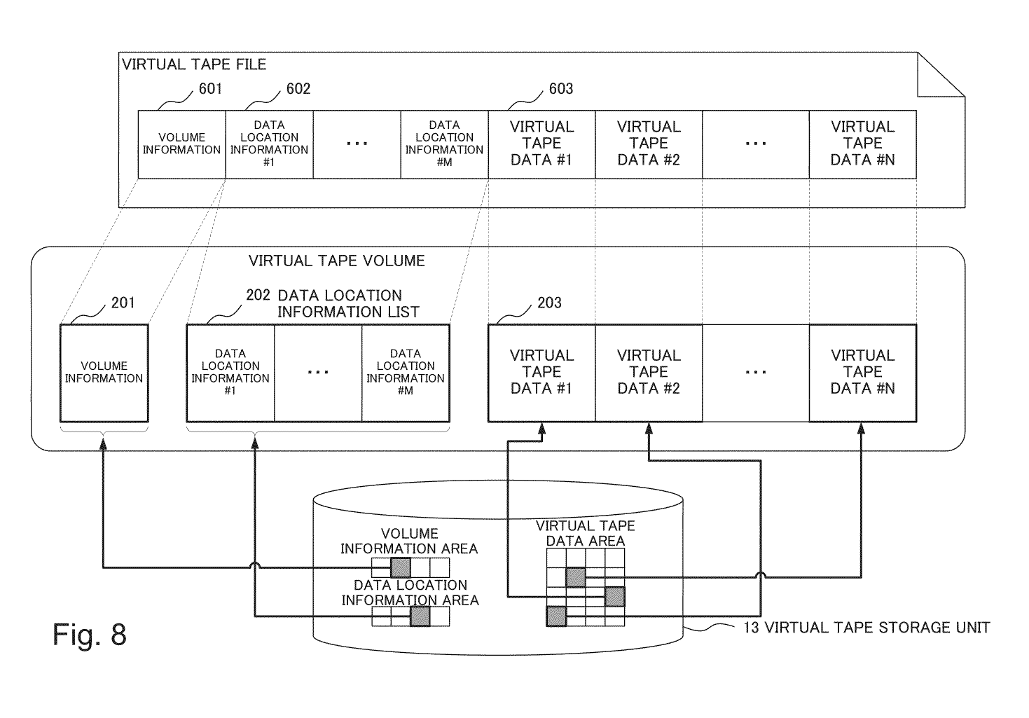

FIG. 8 is a diagram schematically illustrating relationship between the pieces of data stored in a virtual tape volume and the pieces of data stored in a virtual tape file in the present exemplary embodiment. The structure of the virtual tape volume of the present exemplary embodiment is the same as that of the virtual tape volume of the first exemplary embodiment. Accordingly, description of the structure of the virtual tape volume is omitted. As illustrated in FIG. 8, in the present exemplary embodiment, the virtual tape file includes volume information, a data location information list, and pieces of virtual tape data arranged in the order of being stored in the virtual tape volume. In the virtual tape volume, the pieces of the virtual tape data are not necessarily arranged in the order of being stored.

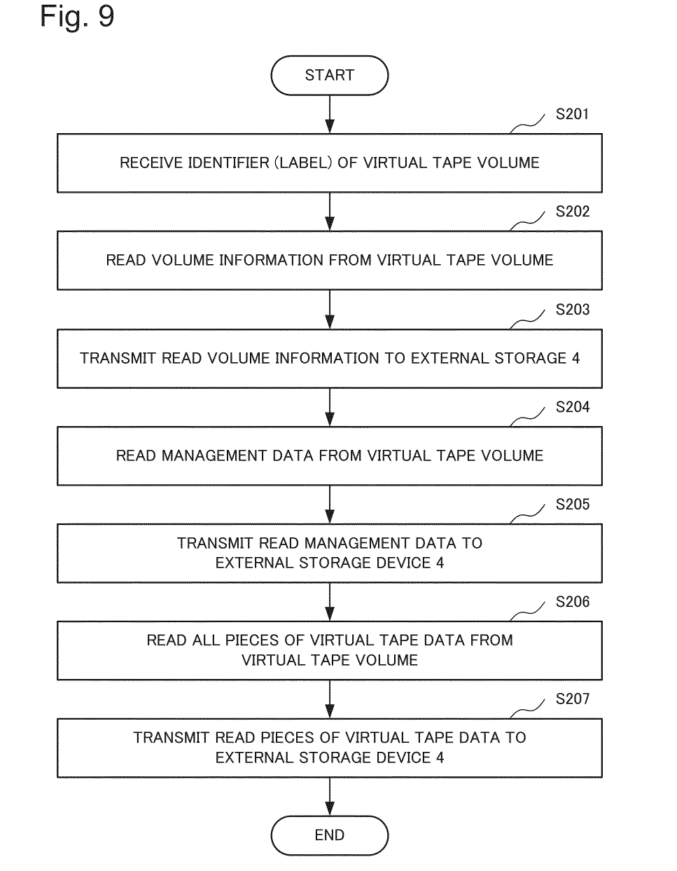

Next, detailed description is given of operation of the virtual tape device 1A of the present exemplary embodiment at the time of transmitting a virtual tape file, with reference to FIG. 9.

FIG. 9 is a flowchart illustrating an example of operation of the virtual tape device 1A of the present exemplary embodiment at the time of transmitting a virtual tape file. As the first exemplary embodiment, the management device 3 transmits, to the virtual tape device 1A, an instruction to transfer the virtual tape volume indicated by a label, consequently starting the operation illustrated in FIG. 9.

First, the conversion unit 14 receives the label of a virtual tape volume (Step S201). The conversion unit 14 reads, via the management unit 12, the volume information in the virtual tape volume indicated by the label (Step S202). Specifically, the conversion unit 14 transmits, to the management unit 12, an instruction to read the volume information in the virtual tape volume indicated by the label. The management unit 12 reads the volume information in accordance with the instruction and transmits the read volume information to the conversion unit 14.

The conversion unit 14 transmits, to the transfer unit 15, an instruction to start to transfer a virtual tape file. The transfer unit 15 starts to transfer the virtual tape file. The conversion unit 14 transmits, to the transfer unit 15, an instruction to transfer, as part of the virtual tape file, the volume information read by the management unit 12, and the volume information. The transfer unit 15 transmits, to the external storage device 4, the volume information read by the management unit 12, as part of the virtual tape file that the transfer unit 15 has started to transfer (Step S203).

The conversion unit 14 similarly transmits, to the management unit 12, an instruction to read the management data (i.e., data location information list) in the virtual tape volume indicated by the label. The management unit 12 receives the instruction. In accordance with the received instruction, the management unit 12 reads the management data from the virtual tape volume indicated by the label (Step S204). The management unit 12 transmits the read management data to the conversion unit 14.

The conversion unit 14 transmits, to the transfer unit 15, an instruction to transmit, to the external storage device 4, the management data read by the management unit 12, as part of the virtual tape file that the transfer unit 15 has started to transfer, and the management data. The transfer unit 15 receives the instruction. In accordance with the received instruction, the transfer unit 15 transmits the management data read by the management unit 12, to the external storage device 4 (Step S205).

Next, the conversion unit 14 transmits, to the management unit 12, an instruction to read all the pieces of the virtual tape data stored in the virtual tape volume indicated by the label. The management unit 12 sequentially reads all the pieces of the virtual tape data from the virtual tape volume, from the piece of the virtual tape data corresponding to the beginning of the virtual tape (Step S206). The management unit 12 transmits the read pieces of the virtual tape data to the conversion unit 14.

The conversion unit 14 transmits, to the transfer unit 15, the pieces of the virtual tape data read by the management unit 12, in the order of being read by the management unit 12. In addition, the conversion unit 14 transmits, to the transfer unit 15, an instruction to transmit, to the external storage device 4, the transmitted pieces of the virtual tape data as part of the virtual tape file that the transfer unit 15 has started to transfer. The transfer unit 15 receives the instruction. In accordance with the received instruction, the transfer unit 15 transmits, to the external storage device 4, the pieces of the virtual tape data as part of the virtual tape file that the transfer unit 15 has started to transfer (Step S207). Upon completion of transmitting all the pieces of the virtual tape data stored in the virtual tape volume indicated by the label, the transfer unit 15 terminates the transmission of the virtual tape file. Then, the virtual tape device 1A terminates the operation illustrated in FIG. 9.

Through the above operation, the virtual tape device 1A transmits the virtual tape file illustrated in FIG. 8 to the external storage device 4.

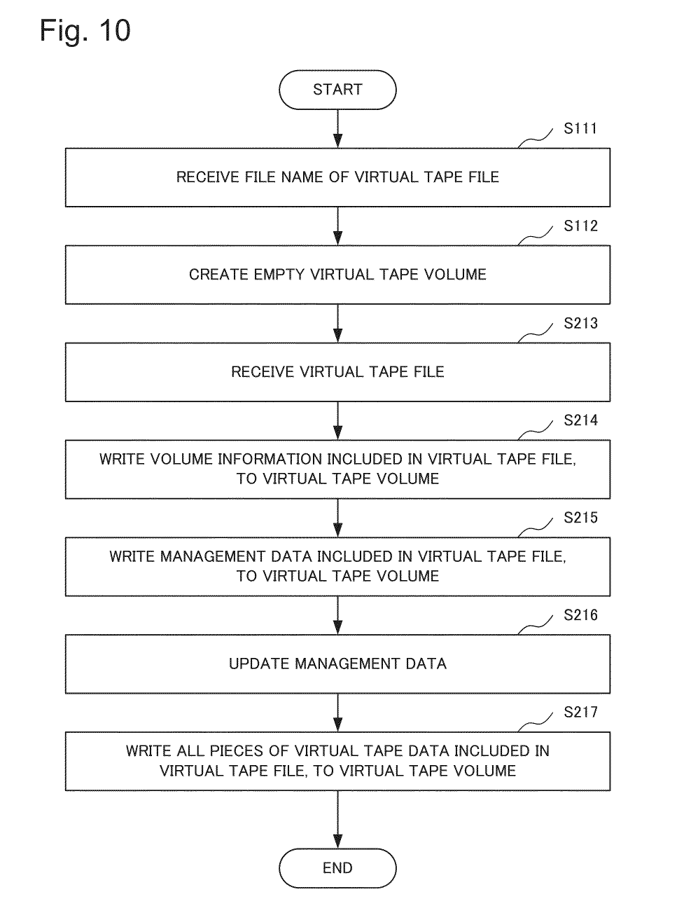

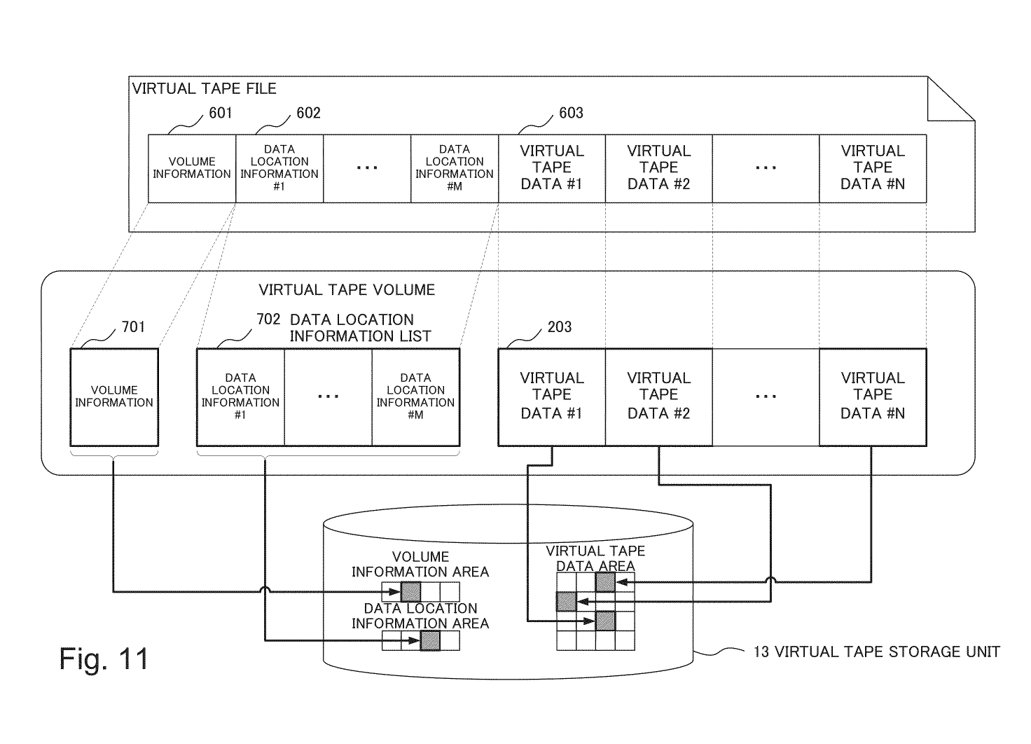

Next, detailed description is given of operation of the virtual tape device 1A of the present exemplary embodiment at the time of receiving a virtual tape file, with reference to the FIGS. 10 and 11.

FIG. 10 is a flowchart illustrating an example of operation of the virtual tape device 1A of the present exemplary embodiment at the time of receiving a virtual tape file. Since the operations in Steps S111 and S112 illustrated in FIG. 10 are the same as those in Steps S111 and S112 illustrated in FIG. 6, description thereof is omitted.

In Step S213, the transfer unit 15 receives a virtual tape file from the external storage device 4. The transfer unit 15 transmits the received virtual tape file to the conversion unit 14.

FIG. 11 is a diagram schematically illustrating relationship between the pieces of the data in a virtual tape file transmitted by the external storage device 4 and the pieces of the data stored in a virtual tape volume in the present exemplary embodiment. As illustrated in FIG. 11, in the present exemplary embodiment, the virtual tape file transmitted by the external storage device 4 includes volume information, a data location information list (i.e., management data) and pieces of virtual tape data.

The conversion unit 14 transmits, to the management unit 12, the volume information included in the virtual tape file and an instruction to write, to the created empty virtual tape volume, the volume information as volume information on the virtual tape volume. The management unit 12 receives the instruction. In accordance with the received instruction, the management unit 12 writes, to the created virtual tape volume, the volume information included in the virtual tape file received from the external storage device 4, as volume information on the virtual tape volume (Step S214).

In the example illustrated in FIG. 11, the management unit 12 writes, to the virtual tape volume, volume information 601 included in the virtual tape file, as volume information 701 on the virtual tape volume without any change.

The conversion unit 14 transmits, to the management unit 12, the management data (i.e., data location information list) included in the virtual tape file received from the external storage device 4 and an instruction to write the management data to the created virtual tape volume as management data. The management unit 12 receives the instruction. In accordance with the received instruction, the management unit 12 writes, to the created virtual tape volume, the management data included in the virtual tape file received from the external storage device 4, as management data on the created virtual tape volume (Step S215).

The conversion unit 14 transmits, to the management unit 12, an instruction to reserve a storage area for storing each of the pieces of the virtual tape data on the basis of the management data written in the created virtual tape file and to update the written management data on the basis of the reserved areas. The management unit 12 receives the instruction. In accordance with the received instruction, the management unit 12 reserves storage areas and updates the written management data accordingly. As described above, the management data corresponds to a data location information list including the data location information on each of the pieces of the virtual tape data. As described above, each piece of the data location information includes a disk storage location, a disk storage length, and a piece of metadata. Among these, the disk storage length and the piece of metadata do not change depending on the location at which the piece of virtual tape data is stored. Accordingly, the management unit 12 reserves a storage area having a length corresponding to the disk storage length for each of the pieces of the data location information included in the data location information list, and writes the location of the reserved area as a disk storage location. The management unit 12 receives the data location information list. Then, the management unit 12 may reserve a storage area corresponding to each disk storage length and update the disk locations in the received data location information list on the basis of the reserved storage areas, before writing the data location information list. The management unit 12 may write the data location information list to the created virtual tape volume as the data location information list of the virtual tape volume, upon completion of all the updates of the data location information list.

In the example illustrated in FIG. 11, the management unit 12 writes, to the virtual tape volume, the data other than the disk locations in the data location information list 602 included in the virtual tape file, as the pieces of data other than the disk locations in the data location information list 702 in the virtual tape volume. The management unit 12 updates the disk locations in the data location information list 702 in the virtual tape volume, on the basis of the locations of the respective pieces of virtual tape data in the virtual tape data area.

Next, the conversion unit 14 transmits, to the management unit 12, the pieces of the virtual tape data included in the virtual tape file received from the external storage device 4 and an instruction to store the pieces of the virtual tape data in the virtual tape volume. The management unit 12 receives the instruction. In accordance with the received instruction, the management unit 12 stores the received pieces of the virtual tape data in the virtual tape volume (Step S217). Upon completion of storing all the pieces of the virtual tape data included in the virtual tape file received from the external storage device 4, the virtual tape device 1A terminates the operation illustrated in FIG. 10.

In the example illustrated in FIG. 11, the management unit 12 writes, to the virtual tape volume, the pieces of the virtual tape data 603 in the virtual tape file as the pieces of the virtual tape data 703 on the virtual tape volume without any change.

The present exemplary embodiment described above has the effect of reducing the load on the virtual tape device 1A at the time of transferring a virtual tape file.

The reason is because the conversion unit 14 creates a virtual tape file having the same data structure as that of the virtual tape volume. Accordingly, the conversion unit 14 does not need to interpret the pieces of the data in the virtual tape volume one by one. In addition, the management unit 12 does not need to read the pieces of the virtual tape data one by one from the virtual tape volume. The management unit 12 may read all the pieces of the virtual tape data together. Hence, the load on the conversion unit 14 and the management unit 12 is reduced.

### Third Exemplary Embodiment

Next, a third exemplary embodiment of the present invention is described in detail with reference to FIGS. 10 and 12 to 15.

Virtual tapes are often used for storing backup data or archive data. In the case of recording backup data on a virtual tape, the identical pieces of data or almost identical pieces of data are recorded on respective virtual tapes. For example, a plurality of identical pieces of the virtual tape data are stored in a virtual tape volume in many cases. By storing such pieces of data in a storage device such as the external storage device 4 having a deduplication function, improvement of the capacity efficiency can be expected.

A virtual tape file in the second exemplary embodiment includes the volume information, the data location information list, and the pieces of the virtual tape data in a virtual tape volume, without changing the data structure. In this case, even when pieces of the virtual tape data are identical, the locations at which the pieces of the virtual tape data are stored are different. Accordingly, the disk locations of the respective pieces of virtual tape data included in the data location information list are different.

When such pieces of data are stored in the external storage device 4 having a deduplication function, the deduplication effect is difficult to obtain or is limited since the disk locations are different.

A disk location corresponds to data generated on the basis of the location at which a corresponding piece of the virtual tape data is stored in the virtual tape volume. Accordingly, the disk location is data not related to a corresponding piece of the user data itself. In addition, the disk location is not needed, for example, in order to transmit, to the external storage device 4, the piece of the virtual tape data read from the virtual tape volume.

Next, description is given of a configuration of an information processing system 100A of the present exemplary embodiment.

FIG. 7 is a block diagram illustrating an example of a configuration of the information processing system 100A of the present exemplary embodiment. The configuration of the information processing system 100A of the present exemplary embodiment is the same as that of the information processing system 100A of the second exemplary embodiment. The constituent elements of the information processing system 100A of the present exemplary embodiment are the same as the constituent elements to which the same numerals are assigned of the information processing system 100A of the second exemplary embodiment, except for the differences described below. Accordingly, description of the same constituent elements is omitted.

A conversion unit 14 of the present exemplary embodiment changes all the disk locations included in the data location information list read by the management unit 12, to the same value. For example, the conversion unit 14 clears, to zero, all the disk locations included in the data location information list read by the management unit 12. The conversion unit 14 transmits the data location information list including the changed disk locations, to the transfer unit 15. Then, the transfer unit 15 transmits, to the external storage device 4, the data location information list including the changed disk locations, as part of the virtual tape file.

The external storage device 4 of the present exemplary embodiment performs deduplication at the time of storing the received data. Deduplication is operation of, when pieces of data to store are identical, storing one of the pieces of the data and associating the stored piece of data with the others of the pieces of the data. Any of various known methods is applicable to a deduplication method executed by the external storage device 4 of the present exemplary embodiment.

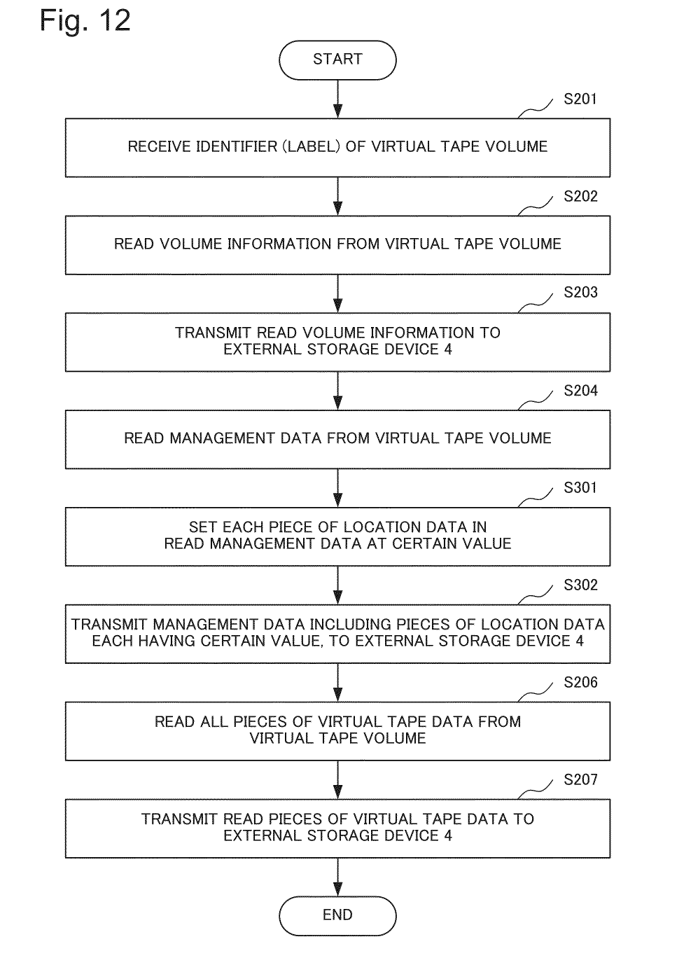

Next, detailed description is given of operation of the virtual tape device 1A of the present exemplary embodiment at the time of transmitting a virtual tape file, with reference to FIG. 12.

FIG. 12 is a flowchart illustrating an example of operation of the virtual tape device 1A of the present exemplary embodiment at the time of transmitting a virtual tape file. In comparison with the operation of the virtual tape device 1A of the second exemplary embodiment illustrated in FIG. 9, the virtual tape device 1A of the present exemplary embodiment performs the operations in Steps S301 and S302 instead of the operation in Step S205 at the time of transmitting a virtual tape file. The operations of the virtual tape device 1A of the present exemplary embodiment in the other steps illustrated in FIG. 12 are the same as those in the steps to which the same numerals are assigned in FIG. 9 of the second exemplary embodiment. For this reason, description of the operations other than those in Steps S301 and S302 in FIG. 12 is omitted below.

In Step S301, the conversion unit 14 changes all the disk locations included in the data location information list read by the management unit 12, to the same value. Specifically, the conversion unit 14 sets a certain value (e.g., 0) for each of the disk locations included in the data location information list read by the management unit 12. The certain value is 0 in the following description.

In Step S302, the conversion unit 14 transmits, to the transfer unit 15, the data location information list to which the change in Step S301 has been made. The transfer unit 15 transmits, to the external storage device 4, the data location information list to which the change in Step S301 has been made and that is received from the conversion unit 14, as part of the virtual tape file that the transfer unit 15 has started to transfer.

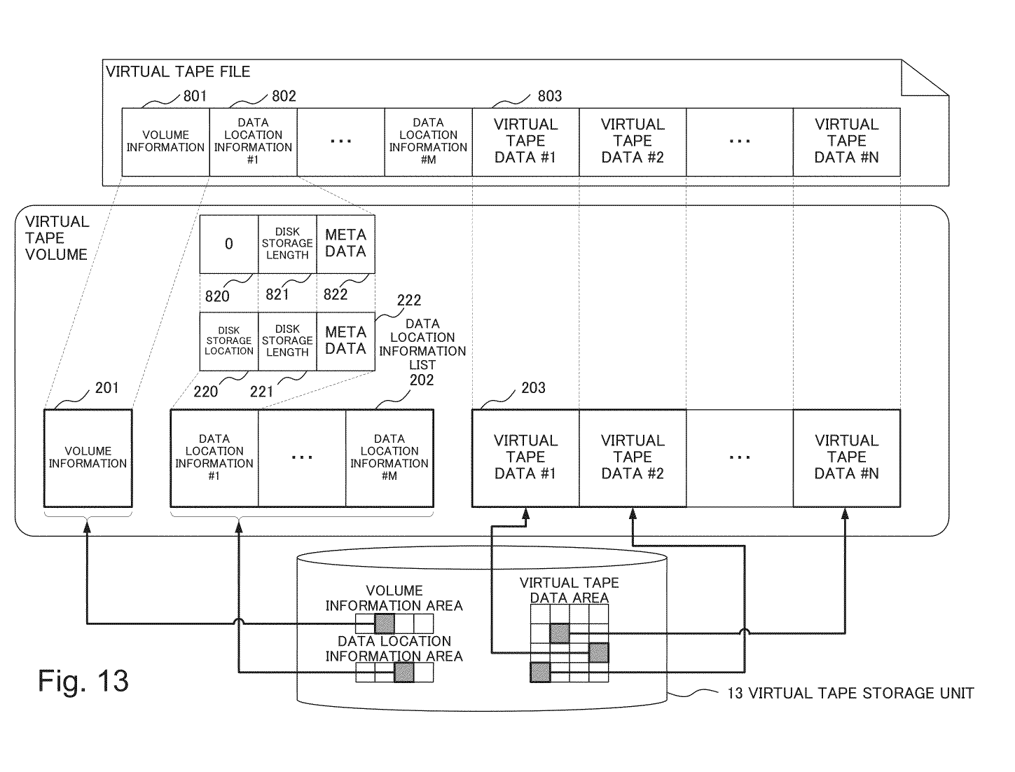

FIG. 13 is a diagram schematically illustrating relationship between the pieces of data stored in a virtual tape volume and the pieces of data stored in a virtual tape file in the present exemplary embodiment.

In the example illustrated in FIG. 13, each disk storage location 220, which is a disk location included in a data location information list 202 in the virtual tape volume, indicates the location at which the corresponding piece of the virtual tape data is located. In contrast, each disk storage location 820, which is the value of a disk location included in a data location information list 802 in the virtual tape file, is cleared to zero by the conversion unit 14. A disk storage length 221 and a piece of metadata 222 are the same as a disk storage length 821 and a piece of metadata 822, respectively. Volume information 801 in the virtual tape file is the same as volume information 201 in the virtual tape volume. In addition, each piece of virtual tape data 803 in the virtual tape file is the same as a corresponding one of virtual tape data 203 in the virtual tape volume.

Next, description is given of operation of the virtual tape device 1A of the present third exemplary embodiment at the time of receiving a virtual tape file.

FIG. 10 is a flowchart illustrating an example of operation of the virtual tape device 1A of the present exemplary embodiment at the time of receiving a virtual tape file. The operation of the virtual tape device 1A of the present exemplary embodiment at the time of receiving a virtual tape file is the same as the operation of the virtual tape device 1A of the second exemplary embodiment at the time of receiving a virtual tape file.

The present exemplary embodiment described above has the effect of being able to reduce the storage capacity necessary for the external storage device 4, which performs deduplication, to store a received virtual tape file, when a different file having the same pieces of user data as those of the received virtual tape file is already stored.

The reason is because the conversion unit 14 sets a certain value for each of the disk locations included in a data location information list.

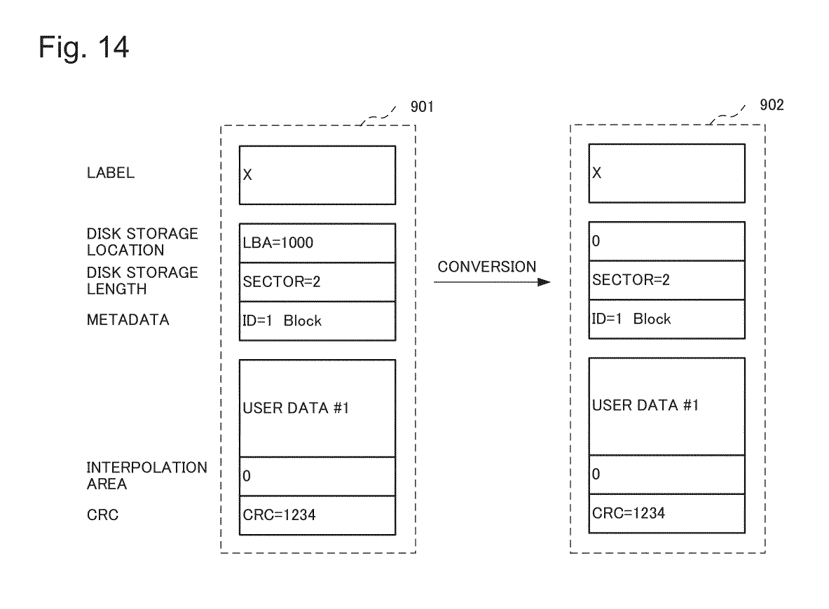

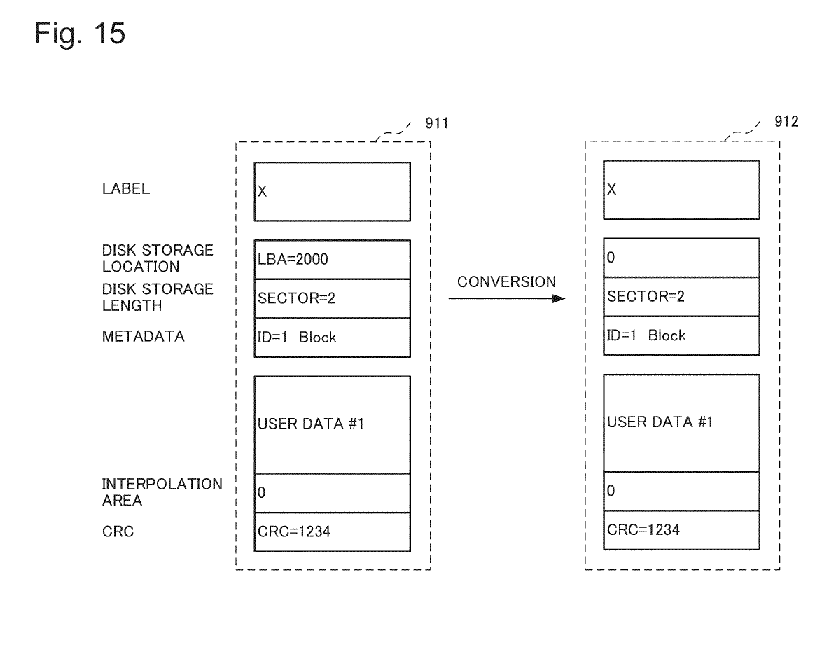

Detailed description is given of the deduplication effect of the present exemplary embodiment with reference to FIGS. 14 and 15.

FIGS. 14 and 15 are diagrams each schematically illustrating an example of a virtual tape before and after conversion in which the conversion unit 14 sets a value for the disk location. A virtual tape 901 in FIG. 14 and a virtual tape 911 in FIG. 15 are pieces of data having the same metadata and user data. However, the data storage location in the virtual tape 901 in FIG. 14 is different from the data storage location in the virtual tape 911 in FIG. 15. The virtual tape 901 and the virtual tape 911 are, for example, pieces of backup data that are created as backups of the same source on different dates.

When the above-described external storage device 4, which performs deduplication, stores the above-described virtual tape 901 and virtual tape 911, the external storage device 4 considers the virtual tape 901 and the virtual tape 911 as different pieces of data since the data storage locations thereof are different. For this reason, there is a possibility that the virtual tape 901 and the virtual tape 911 are not considered as targets for deduplication.

A virtual tape 902 illustrated in FIG. 14 is the virtual tape 901 for which conversion for setting a certain value for the disk location (disk storage location) has been performed by the conversion unit 14 of the present exemplary embodiment. Similarly, a virtual tape 912 illustrated in FIG. 15 is the virtual tape 911 for which conversion for setting a certain value for the disk location has been performed by the conversion unit 14 of the present exemplary embodiment. The virtual tape 902 and the virtual tape 912 are the same. Accordingly, when the external storage device 4, which performs deduplication, stores the above-described virtual tape 902 and virtual tape 912, the virtual tape 902 and the virtual tape 912 are considered as targets for deduplication.

As described above, in the case where there are a virtual tape file and a different file having the identical pieces of user data, the conversion unit 14 of the present exemplary embodiment sets a certain value for each of the disk locations, which makes the contents of the files identical. When such a plurality of files are stored in the external storage device 4, which performs deduplication, the plurality of files are considered as targets for deduplication. Hence, the storage capacity necessary for the external storage device 4 to store virtual tape files is able to be reduced.

### Fourth Exemplary Embodiment

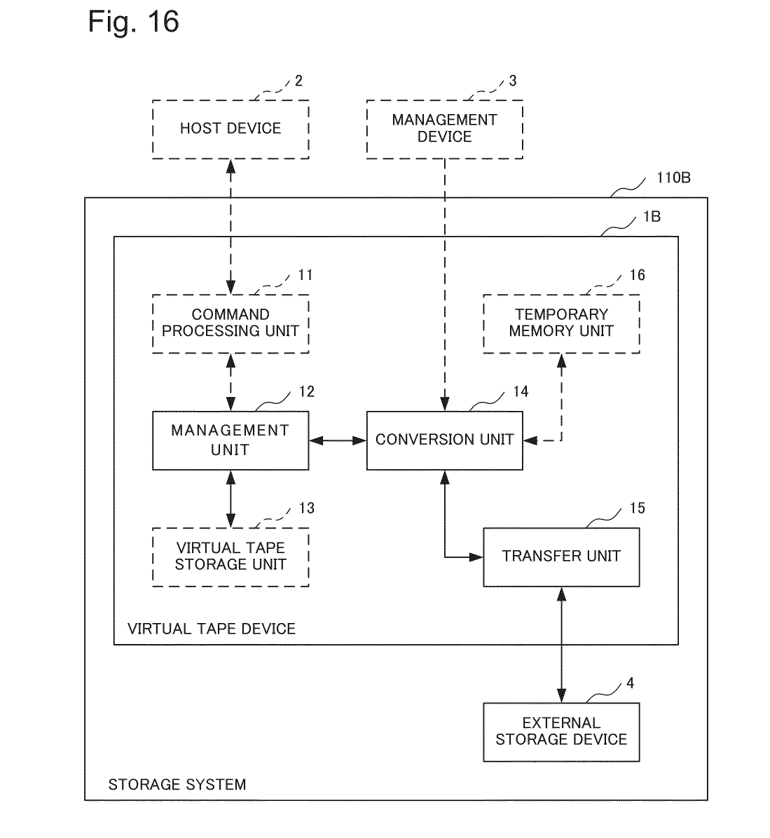

Next, a fourth exemplary embodiment of the present invention is described in detail with reference to FIG. 16. The present exemplary embodiment presents a concept common to all the above-described exemplary embodiments.

FIG. 16 is a block diagram illustrating an example of a configuration of a storage system 11B of the present exemplary embodiment.

According to FIG. 16, the storage system 110B of the present exemplary embodiment includes: a virtual tape device 1B, which includes a management unit 12, a conversion unit 14, and a transfer unit 15; and the external storage device 4. The management unit 12 reads a data set from a virtual tape storage unit 13, which stores the data set. The data set is data in which pieces of virtual tape data each including a piece of user data saved in a virtual tape are associated with management data including pieces of location data on the respective storage locations at which the pieces of virtual tape data are stored. The conversion unit 14 generates a virtual tape file including the data set. The transfer unit 15 transmits the virtual tape file as transfer data, to the external storage device 4. Upon receipt of the transfer data, the external storage device 4 stores the transfer data.

The present exemplary embodiment described above has the same effect as that of the second exemplary embodiment. The reason is the same as that of producing the effect of the second exemplary embodiment.

### Other Exemplary Embodiments

Each of the virtual tape device 1, the virtual tape device 1B, and the virtual tape system 110B can be implemented by using a computer with a program which controls the computer. Alternatively, each of the virtual tape device 1, the virtual tape device 1B, and the virtual tape system 110B may be implemented by using dedicated hardware. Each of the virtual tape device 1, the virtual tape device 1B, and the virtual tape system 110B may be implemented by using a combination of a computer with a program which controls the computer and dedicated hardware.

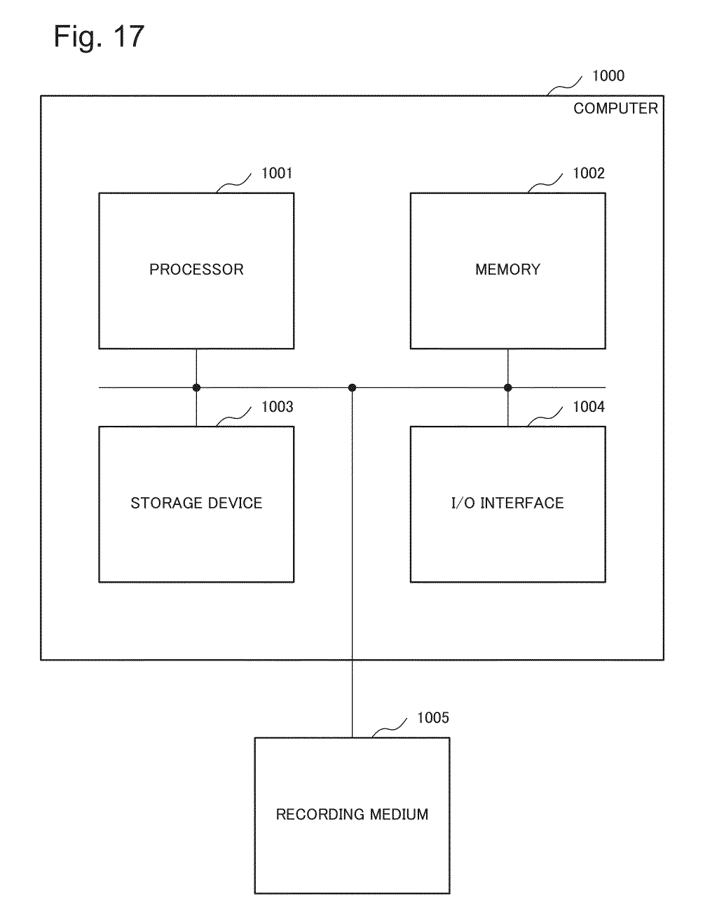

FIG. 17 is a diagram illustrating an example of a hardware configuration of a computer 1000 which is able to be used for implementing any of the virtual tape device 1, the virtual tape device 1B, and the virtual tape device 110B. According to FIG. 17, the computer 1000 includes a processor 1001, a memory 1002, a storage device 1003, and an input/output (I/O) interface 1004. The computer 1000 is able to access a recording medium 1005. The memory 1002 and the storage device 1003 are, for example, a random access memory (RAM) and a storage device such as hard disk. The recording medium 1005 is, for example, a RAM, a storage device such as hard disk, a read only memory (ROM), or a portable recording medium. The storage device 1003 may be the recording medium 1005. The processor 1001 is able to read data and programs from the memory 1002 and the storage device 1003 and is able to write data and programs to the memory 1002 and the storage device 1003. The processor 1001 is able to access the host device 2, the management device 3, and the external storage device 4 via, for example, the I/O interface 1004. The processor 1001 can access the recording medium 1005. The recording medium 1005 stores a program causing the computer 1000 to operate as the virtual tape device 1, the virtual tape device 1B, or the virtual tape device 110B.

The processor 1001 loads, into the memory 1002, the program, which is stored in the recording medium 1005, causing the computer 1000 to operate as the virtual tape device 1, the virtual tape device 1B, or the virtual tape device 110B. When the processor 1001 executes the program loaded into the memory 1002, the computer 1000 operates as the virtual tape device 1, the virtual tape device 1B, or the virtual tape device 110B.

The command processing unit 11, the management unit 12, the conversion unit 14, and the transfer unit 15 are able to be implemented, for example, by using: the processor 1001 executing a dedicated program that is loaded into the memory 1002 from the recording medium 1005 storing the program and that is able to cause the processor to function as each of the units described above; and the dedicated program. The virtual tape storage unit 13 and the temporary memory unit 16 are able to be implemented by using the memory 1002 and the storage device 1003 such as hard disk drive included in the computer 1000. Alternatively, one or more of the command processing unit 11, the management unit 12, the virtual tape storage unit 13, the conversion unit 14, the transfer unit 15, and the temporary memory unit 16 may be implemented by using dedicated circuitry which functions as the respective units.

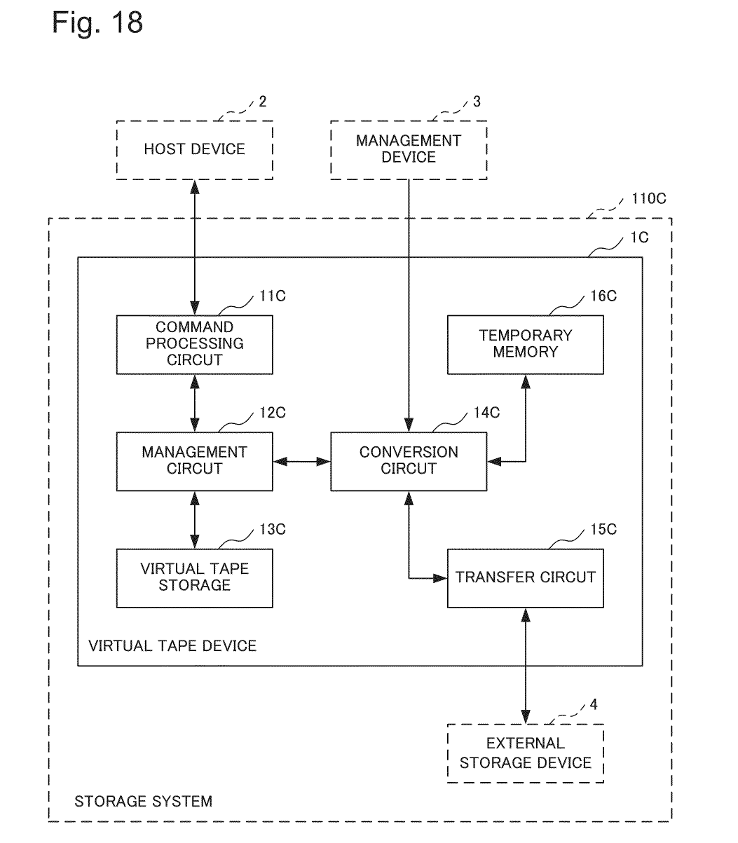

FIG. 18 is a block diagram showing an example of a structure of a virtual tape device according to the exemplary embodiments of the present invention. A virtual tape device 1C shown in FIG. 18 includes a command processing circuit 11C, a management circuit 12C, virtual tape storage 13C, a conversion circuit 14C, a transfer circuit 15C, and a temporary memory 16C.

The command processing circuit 11C, the management circuit 12C, the conversion circuit 14C, the transfer circuit 15C, and the temporary memory 16C may be implemented as a circuit. The command processing circuit 11C, the management circuit 12C, the conversion circuit 14C, the transfer circuit 15C, and the temporary memory 16C may be implemented as two or more circuits. The command processing circuit 11C, the management circuit 12C, the conversion circuit 14C, the transfer circuit 15C, and the temporary memory 16C may be the memory 1002 storing a program causing the processor 1001 to operate as the virtual tape device 1, 1A or 1B and the processor 1001 executing the program loaded into the memory 1002, which are included in the computer 1000 shown in FIG. 17.

The command processing circuit 11C operates as the command processing unit 11. The management circuit 12C operates as the management unit 12. The virtual tape storage 13C shown in the FIG. 18 is the same as the virtual tape storage unit 13 shown in FIG. 1. The conversion circuit 14C operates as the conversion unit 14. The transfer circuit 15C operates as the transfer unit 15.

A virtual tape device is categorized into a device called near-line storage or off-line storage. Such device is a storage device that stores data and is allowed to take time to restore the data when the original data of the stored data is lost due to disaster or the like. However, it is required to reduce a cost of such device instead. It is also required to reduce a cost in a case of saving, at a remote site, a copy of data stored in a virtual tape device.

In the technologies of PTLs 2 and 3 described above, a magnetic tape or an external storage medium in which virtual tapes are stored is created as a copy of data stored in a virtual tape device. In order to save such a copy at a remote site, the recording medium such as the magnetic tape or the external storage medium needs to be physically transported to the remote site. In general, such a copy is regularly created, and hence, employing the technique according to PTL 2 or 3 requires transportation costs of regularly transporting a recording medium to a remote site, as operation costs.

As a method of saving, at a remote site, a copy of the data stored in a virtual tape device, there is a method of storing a copy of data in a virtual tape device provided in the remote site, for example. Employing this method does not require a media storing the data to be physically transported, which can reduce operation costs. However, a virtual tape device for saving needs to be prepared at the time of installation, which requires high installation costs.

As a method of saving, at a remote site, a copy of the data stored in a virtual tape device, a conceivable method is one in which backup data is stored, for example, in network attached storage (NAS) or cloud storage provided in the remote site.

As such a method, there is a method in which a host device using the virtual tape device reads out user data recorded in a virtual tape, generates a file including the user data in a format supported by the host device, and stores the generated file in a storage in a remote site. An alternative method is one in which a virtual tape device directly stores, in a storage in a remote site, data in a virtual tape recorded in a magnetic disk as a file, which allows the data in the virtual tape to be saved at the remote site without involving the host device.

In the former case, the host device processes the user data read out from the virtual tape by use of the resources of the host device, which exerts load on the host device.

In the latter case, as disclosed in the technology of PTL 4, the system that creates a copy needs to include a device having a function of generating management information on the system that receives the copy, and the system that receives the copy needs to include a device having the function of interpreting the management information. This makes it difficult to expect a significant reduction in installation cost in comparison with the case of preparing a virtual tape device for replication.

In the technique of PTL 1, a copy of a virtual tape is stored in the same magnetic disk as that storing the original virtual tape. For this reason, it is not possible to use the technique of PTL 1 for saving a copy at a remote site.

The present invention has the effect of being able to reduce the cost of backing up a virtual tape without increasing the load on the host device.

The previous description of exemplary embodiments is provided to enable a person skilled in the art to make and use the present invention. Moreover, various modifications to these exemplary embodiments will be readily apparent to those skilled in the art, and the generic principles and specific examples defined herein may be applied to other exemplary embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A storage system comprising:
a virtual tape device that includes circuitry configured to operate as
a management unit that reads a data set from a virtual tape storage unit that stores the data set, the data set including, in an associated manner, a piece of virtual tape data including a piece of user data stored in a virtual tape and management data including a piece of location data indicating a storage location at which the piece of virtual tape data is stored,
a conversion unit that generates a virtual tape file including the data set, and
a transfer unit that transmits the virtual tape file as transfer data to an external storage device; and
the external storage device that stores the transfer data upon receipt of the transfer data.

2. The storage system according to claim 1, wherein
the conversion unit converts the read data set so that, when contents of two or more pieces of user data, each corresponding to the piece of user data, are identical, contents of two or more data sets, each corresponding to the data set, are considered as identical, and,
upon receipt of the transfer data, the external storage device does not store the transfer data when already storing data the content of which is identical to that of the transfer data, and stores the transfer data when storing no data the content of which is identical to that of the transfer data.

3. The storage system according to claim 2, wherein
the conversion unit converts the read data set so as to eliminate part that does not depend on the content of the piece of user data.

4. The storage system according to claim 2, wherein
the management data includes location data indicating a storage location at which the virtual tape data is stored in the virtual tape storage unit, and,
upon reading of the data set, the conversion unit converts the read data set so as to set, at a certain value, the location data in the management data included in the read data set.

5. The storage system according to claim 1, wherein
the management unit extracts the piece of user data from the data set, and
the conversion unit generates a virtual tape file composed of the piece of user data.

6. The storage system according to claim 1, wherein
the virtual tape device further includes the virtual tape storage unit.

7. A storage system control method comprising:
reading, by a virtual tape device, a data set from a virtual tape storage unit that stores the data set, the data set including, in an associated manner, a piece of virtual tape data including a piece of user data stored in a virtual tape and management data including a piece of location data indicating a storage location at which the piece of virtual tape data is stored;
generating, by the virtual tape device, a virtual tape file including the data set;
transmitting, by the virtual tape device, the virtual tape file as transfer data to an external storage device; and
storing, by the external storage device, the transfer data upon receipt of the transfer data.

8. The storage system control method according to claim 7, wherein
the virtual tape device converts the read data set so that, when contents of two or more pieces of user data, each corresponding to the piece of user data, are identical, contents of two or more data sets, each corresponding to the data set, are considered as identical, and,
upon receipt of the transfer data, the external storage device does not store the transfer data when already storing data the content of which is identical to that of the transfer data, and stores the transfer data when storing no data including the content of which is identical to that of the transfer data.

9. The storage system control method according to claim 8, wherein the virtual tape device converts the read data set so as to eliminate part that does not depend on the content of the piece of user data.

10. The storage system control method according to claim 8, wherein
the management data includes location data indicating a storage location at which the virtual tape data is stored in the virtual tape storage unit, and,
upon reading of the data set, the virtual tape device converts the read data set so as to set, at a certain value, the location data in the management data included in the read data set.

11. The storage system control method according to claim 7, wherein
the virtual tape device
extracts the piece of user data from the data set, and
generates a virtual tape file composed of the piece of user data.

12. A non-transitory computer-readable recording medium that stores a virtual tape device control program causing a computer to operate as:
a management unit that reads a data set from a virtual tape storage unit that stores the data set, the data set including, in an associated manner, a piece of virtual tape data including a piece of user data stored in a virtual tape and management data including a piece of location data indicating a storage location at which the piece of virtual tape data is stored;
a conversion unit that generates a virtual tape file including the data set; and
a transfer unit that transmits, upon receipt of the transfer data, the virtual tape file as transfer data to an external storage device that is to store the transfer data.

13. The non-transitory computer-readable recording medium that stores the virtual tape device control program according to claim 12, wherein
the conversion unit converts the read data set so that, when contents of two or more pieces of user data, each corresponding to the piece of user data, are identical, contents of two or more data sets, each corresponding to the data set, are considered as identical, and,
upon receipt of the transfer data, the external storage device does not store the transfer data when already storing data the content of which is identical to that of the transfer data, and stores the transfer data when storing no data the content of which is identical to that of the transfer data.

14. The non-transitory computer-readable recording medium that stores the virtual tape device control program according to claim 13, wherein
the conversion unit converts the read data set so as to eliminate part that does not depend on the content of the piece of user data.

15. The non-transitory computer-readable recording medium that stores the virtual tape device control program according to claim 13, wherein
the management data includes location data indicating a storage location at which the virtual tape data is stored in the virtual tape storage unit, and,
upon reading of the data set, the conversion unit converts the read data set so as to set, at a certain value, the location data in the management data included in the read data set.

16. The non-transitory computer-readable recording medium that stores the virtual tape device control program according to claim 12, wherein
the management unit extracts the piece of user data from the data set, and
the conversion unit generates a virtual tape file composed of the piece of user data.
